(19) United States
(12) Patent Application Publication
(10) Pub. No.: US 2005/0175969 A1
(43) Pub. Date: Aug. 11, 2005

(54) Dyslexia glasses that remove the problems associated with visual dyslexia

(76) Inventor: John Atley Hayes, Atlantic Beach, FL (US)

Correspondence Address: JOHN ATLEY HAYES, 240 BELVEDERE STREET, ATLANTIC BEACH, FL, 32233, US

(21) Appl. No.: 11/054,807

(22) Filed: Feb. 10, 2005

Related U.S. Application Data
(60) Provisional application No. 60/543,778, filed on Feb. 11, 2004.

(51) Int. Cl. G09B 17/00

(52) U.S. Cl. 434/184

(57) ABSTRACT

Visual dyslexia is characterized as a condition where an assortment of visual problems make reading difficult for dyslexics. When worn, dyslexia glasses using lenses made from didymium glass inserted into eyeglass frames have proven themselves in the marketplace to remove those problems for dyslexics that have a visual component to their reading difficulties.

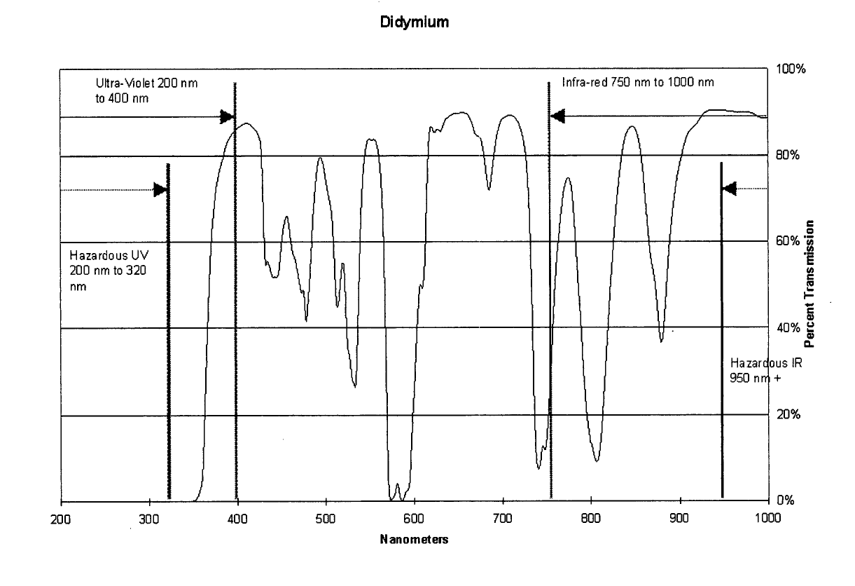

### CROSS-REFERENCE TO RELATED APPLICATIONS

Provisional patent application No. 60/543.778 filed on Jan. 11, 2004

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

A portion of the disclosure of this patent document contains material to which a claim for copyright is made. The copyright owner has no objection to the facsimile reproduction by anyone of the patent document or the patent disclosure as it appears in the Patent and Trademark Office Patent file or records, but reserves all other copyright rights whatever.

References Cited U.S. Patent Documents

| | | | |
|---|---|---|---|
| 4379699 | October, 1980 | Nelson | 434/184 |
| 4706686 | November, 1987 | Levinson | 600/558 |
| 4889422 | December, 1990 | Pavlidis | 351/210 |
| 4961640 | October, 1990 | Irlen | 351/44 |
| 4979902 | December, 1990 | Morelle | 434/184 |
| 5420653 | May, 1995 | Mumford | 351/246 |
| 5844721 | December, 1998 | Karpen | 362/510 |
| 6382791 | May, 2002 | Strawderman | 351/203 |
| 6398729 | June, 2002 | Levinson | 600/300 |
| 6416867 | July, 2002 | Karpen | 428/426 |
| 6443572 | September, 2002 | Lawson | 351/203 |
| 6729729 | May, 2004 | Irons | 351/242 |
| 20030219787 | November, 2003 | Kere, Juha | 435/6 |
| 20030223036 | December, 2003 | Anderson | 351/205 |
| 20040138441 | July 2004 | Kere, Juha | 435/6 |

### OTHER REFERENCES

Dannmeyer F., Das Neophanglas als nautisches Hilfsmittel bei unklarer Sicht, Die
Glashutte; 1934, No. 4, pp. 49-50. (includes English translation)
Gouras, P. and E. Zrenner, “Color Vision”, A Review from a Neurophysicalogical Perspective; in progress in Sensory Physiology, 1; Springer-Verlag Berlin-Meidelberg, NY 1981
Waltman, S R: Quantitative vitreous fluorophotometry. A sensitive technique for measuring early breakdown of the blood-retinal barrier in young diabetic patients; Diabetes 1978 February; 27(2)85-7
Lightstone, A; Both coloured overlays and coloured lenses can improve reading fluency, but their optimal chromaticities differ; Ophthalmic Physiol Opt. 1999 July; 19(4)279-85
Fumihiko Mori; Changes in corneal and lens autofluorescence and blood glucose levels in diabetics: parameters of blood glucose control; Current Eye Research 1997, Vol 16 No. 6, pp 534-538
Eldred, G E; Lipofuscin: resolution of discrepant fluorescence data; Science, 1982, 216, 757-759
Ygge, J; Visual functions in a Swedish population of dyslexic and normal reading children; Acta Ophthalmol (Chpenh). 1993 February; 71(1):1-9
Prager, T C; Vitreous fluorophotometry: identification of sources of varibility; Invest Ophthalmol Vis Sci. 1981 December; 21(6):854-64
Gregorio Weber: Published in Biophysical Journal 75:419-421 (1998)
Wilkins, A. J. (1994) Double-masked placebo controlled trial of precision spectral filters in children who use coloured overlays; Ophthalmic Physiological Optics, 14, 365-370
Robinson, G; (1999) Scotopic sensitivity/Irlen syndrome and the use of: A long term placebo controlled and masked study of reading achievement and perception of ability; Perceptual and Motor Skills, 89, 83-113
Solman, R. T.; Color-mediated contrast sensitivity in disabled readers; Otom Vis Sci. 1991 May; 68(5):331-7
CRC Handbook of Chemistry and Physics, 68th Edition, 1987-1988, p B-2
Marmorstein, Alan D.; (2002) Spectral Profiling of Autofluorescence Associated with Lipofusin, Bruch's Membrane and Sub-RPE Deposits in Normal and AMD Eyes; Investigative Ophtalmology and Visual Science. 2002; 43:2435-2441

This invention relates to the field of treatment of visual perceptual impairments associated with dyslexia, a reading disorder of undetermined cause. The visual perceptual impairments associated with dyslexia include a broad range of visual symptoms or problems which make it difficult to see and comprehend the written word. The discovery that a particular filter, when installed as lenses in eyeglass frames and worn by the visual dyslexic, extinguishes the visual perceptual impairments from all that suffer them without the need for expensive individual evaluations is a giant leap forward for the treatment of visual dyslexia.

Dyslexia can be considered as a condition involving poor processing of written information and as such has involved research that has studied the eye, ear and brain. There have been indications that implicate all as being associated with dyslexia. Genetic research reveals several genes that correlate with dyslexia which as dyslexia has been known to run in families is not surprising. Kere U.S. patent applications 20040138441 and 20030219787 has identified 2 more novel genes functionally related to dyslexia since 2003.

Dyslexia is a specific learning disability and is indicated as a large difference between an individual's apparent intelligence and their reading and language skills. It is often said that dyslexics are of average to above intelligence. California has decided that the best way to identify dyslexics is by definition which is unfortunate. Their definition is that any child falling 2 grade levels below in reading skills is dyslexic. This is certainly going to dilute the population of dyslexics with truants and others that have no disability except that of having poor teachers.

Tests that measure reading rate, fluency, accuracy and comprehension together with age and IQ have been used to help quantify the degree of dyslexia in an individual. These results often are used to develop expensive and time consuming teaching strategies that have proved to be successful for some dyslexics. Mumford U.S. Pat. No. 5,420,653 uses the speed of reading similar numbers accurately as an indication of dyslexia. Advocates of dyslexia as a hearing disorder use intensive teaching of the sounds associated with letters and letter groups to improve reading skills.

The invention of this patent actually deals with the subgroup of dyslexics that have a visual component to their condition which is often called visual dyslexia. Visual dyslexia is characterized by a long list of visual problems that make reading difficult. Some common problems are those that involve motion such as having words and letters seem to jump around or seem to be jittery. Having difficulty seeing all the letters such as missing letters at the beginning, middle or ends of words or letters transposing their positions or running together without spaces is also commonly reported. Problems involving light are sometimes described as trying to read through a waterfall or having light obscure parts of words or having a bothersome halo effect. Focusing problems where a word needs to be concentrated on before coming clear or when words seem to need to float to the surface of the page before they can be read as well as being called fuzzy have also been described. All these problems and more are removed when using this invention to read. Poor depth perception is also common in visual dyslexics and while not usually considered a reading problem normal depth perception is restored with the use of the invention.

That some people are more sensitive to physical stimulus by their senses is commonly known and has been observed by everyone. While “The Princess and the Pea” is a fairy tale, differences in pain tolerance are well documented. As children most of us have observed the different reactions to the sound made by running fingernails down a blackboard. Food and wine critics are more sensitive to differences in taste. I have had friends that have identified my having a bad potato in the cupboard before I was even aware of an odor. Just as finding Waldo, for those without children a task that involves finding Waldo out of a deliberately visually confusing background in a series of books called “Find Waldo”, can be considered both a visual and mental exercise, there is assumed to be mental processing component with all of our senses that determines a person's sensitivity to physical stimulus. It is likely that visual dyslexics are more sensitive to visual distortion caused by the stimuli that the dyslexia glasses remove. Just as restraining that brat at the blackboard or throwing out that bad potato removes those annoying stimuli for those sensitive to them, these dyslexia glasses remove the stimuli that causes the visual problems of visual dyslexia.

There are many testing and screening methods based on the different theories developed from data that indicate characteristics having a higher occurrence in dyslexics. Ygge published in 1993 that dyslexics have lower near and far visual acuity as well as lower contrast sensitivity. Levinson U.S. Pat. Nos. 4,706,686 and 6,398,729 makes use of the fact that reading requires the eyes to move and analyzed visual problems generated by moving the reader or the subject matter while reading as a screening method for dyslexia. Pavlidis U.S. Pat. No. 4,889,422 uses an instrument that measures eye movement and correlates types of eye movement with dyslexia. Both Levinson and Pavilidis apparently consider the eye movement as the cause rather than the effect of the visual dysfunction while I consider that eye movement is the result rather than the cause. Their use of eye movement as a screening method for detection of dyslexia I feel is fine. Lawson U.S. Pat. No. 6,446,572 suggests treating the problem by training the eye by vision training exercises to achieve stable fixation of the eye. I believe the problem will be corrected by this invention in a much easier way. Strawderman U.S. Pat. No. 6,382,791 has another method of visual training based on increasing skill in recognizing objects by dyslexics that again I feel would be more easily solved with my invention.

The best known remedial treatment for visual dyslexia is Irlen U.S. Pat. No. 4,961,640 which has the goal of determining the best color of tinted lenses to improve a dyslexic's vision. This is done by going through several series of color filters and asking the client is this one better than that one. Irlen coined the term Scotopic Sensitivity Syndrome or (SSS) and many have been puzzled by the term as scotopic vision refers to the light sensitive retinal receptors called rods while her precision tints are colored and must involve the detail sensitive cones which are involved in reading. Solman (1991) found that colored filters mediated contrast sensitivities in disabled readers. Lightstone (1999) reported reading rates improved when the subject picked the color of overlays and when the tint of the filter was determined by Colorimeter. Wilkins (1994) reported that prescribed colored filters reduced the symptoms of (SSS) better than the placebo filters although the placebo reduced the symptoms also. Robinson (1999) basically said that improvements were made by blue, placebo and prescribed filter groups regardless of filter type. Irons U.S. Pat. No. 6,729,729 determines the color of overlays and a vdu screen for optimal visual performance by gathering data from reading tests while going through a series of three colorimetric parameters, another time consuming process.

Irlen discloses in her patent that 60-80% of her patients who are diagnosed as having scotopic sensitivity syndrome (SSS) report complete symptomatic relief. She also discloses that it is the rods over stimulation by individual specific wavelengths from the 425-575 NM range that determines the best color of filter for a specific patient. I have a much more simplistic but effective approach for my invention by self identification of who might be helped. In order to identify the subgroup of dyslexics that will be helped, I start by saying that my invention helps dyslexics with visual dyslexia. Diagnosed dyslexics who are the ones normally seeking treatment seem to be quite good at knowing if their problem has a visual component. Asking them to consider their response to the following statement: I find it difficult to read because. I explain that if the answer is because the words will not stay still, not stay in focus, or never seem to be spelled the same as well as a number of other characteristics of visual dyslexia that the dyslexia glasses will remove those problems. I also explain that if they see the printed page in a clear, stable and focused manner that the dyslexia glasses will not help. I call the dyslexia glasses See Right Dyslexia Glasses and they have been sold on the web since April 2003 with a 100% satisfaction and 100% money back guarantee. There has been about a 5% return rate.

I do not suggest that posting on the web some information and having the interested dyslexics ask themselves to try to self evaluate if their dyslexia has a visual component is a method that I am trying to patent. Indeed it is having no method and allowing for the self evaluation of visual dyslexia along with the 100% satisfaction and 100% money back guarantee that shows one of the novel and valuable contributions to the state of the art.

While the 100% satisfaction and 100% money back guarantee can not be considered novel for some products, the dyslexia industry usually uses what I call weasel guarantees when a guarantee is offered at all. Results guaranteed means nothing when you consider that even negative results are results. I list a few acceptable reasons for returning the dyslexia glasses on the web. My car's gas mileage didn't increase by 30% when I wore the See Right Dyslexia Glasses is one.

I also do not use the term scotopic sensitivity syndrome (SSS) as I do not believe that it adequately reflects the mechanism of what causes visual dyslexia. I will describe later a mechanism causing the visual distortion of light to the rods and cones at a range of wavelengths wider than the 425-575 NM range and other properties of the filter used in See Right Dyslexia Glasses that make them effective at giving complete systematic relief of visual dyslexia.

Because I have chosen one filter to use for the removal of the visual problems of visual dyslexia, there is no need for the consumer to go through expensive testing to determine which filter works or doesn't work for them. This is made possible by filtering a combination of different wavelengths in the same filter that addresses what I believe is the real cause of visual dyslexia. I consider that removing the need to have a personal evaluation to determine a specific filter for a specific dyslexic which may have a 60-80% success rate and instead having a single filter with a 95% success rate without the need to charge for any evaluation is a large improvement in the state of the art.

Morelle U.S. Pat. No. 4,979,902 discloses a reading device for dyslexics made by glasses that use a small aperture similar to a pin hole camera. While it's intended function is to reduce eye movements I suggest that a large reduction in the amount of light available to the eye probably helps and is consistent to some extent with reducing light by the use of filters as a valid concept. Likewise Nelson U.S. Pat. No. 4,379,699 discloses that print systems consisting of white letters on a black background as being helpful to dyslexics could be thought of as reducing the amount of glare by reducing the area of reflective white. The See Right Dyslexia Glasses are very effective at reducing the amount of glare.

Anderson U.S. patent application 20030223036 uses a system of lights capable of generating a light field individually suited to dyslexics from different colored light sources that are added to ambient light to determine the best tint for tinted filters for that dyslexic. How well the dyslexic reads is used to determine what combination works best. I believe that the ambient light imposes a limitation on how well the method may work as well as the fact that is in common with all the other techniques to determine the best individual tint and that is that not all of the problem exists in the wavelengths investigated.

The one common thread in the prior art of determining the proper tint for the relief of symptoms of (SSS) or my preferred term, visual dyslexia, is that the assumptions Irlen made are true i.e. the answer must be individual specific and in the portion of wavelengths of light between 425-575 NM. As visual dyslexia is a vision problem that involves poor visual performance characterized by sensitivity to glare and poor visual acuity I would like to shift the focus away from individualistic precision tints to Karpen U.S. Pat. No. 6,416,867, reduced glare neodymium containing window glass. What his invention does is to reduce the amount of yellow light transmitted since reducing the amount of yellow light in the spectrum improves color rendition, sharpness and reduces glare. In Karpen U.S. Pat. No. 5,844,721 where Karpen proposes Neodymium containing glass for use as a rear view mirror he coincidentally uses as an example of suitable glass S-8801 from Schott Glass Technologies the didymium filter glass I use in the dyslexia glasses. Karpen used an historical reference that I was unfamiliar with but eloquently describes the visual effects of neodymium glass. Thank you Karpen.

Dannmeyer (1934) made an investigation of Neodymium Oxide containing Neophane glass as a vision aid in bad weather for navigational purposes. If one looks at a spectrum through this glass, one will notice that yellow is eliminated, but red and green appear much clearer. If one looks at a landscape, even in murky weather, one will see wonderful lustrous colors, emphasizing everything red and even green. But there is another special effect: the discomforting blinding effect created principally by yellow disappears at the same time. If one looks at a bare tree against a bright sky, one won't be able to see the ends. They disappear in the general glare. If, however, one looks through the Neodymium Oxide glass, or as it is now technically called, Neophane glass, even the slightest differences are emphasized. All blinding effects against the clear sky or sun disappear and the elements of the optical picture appear more sharply even when looking towards the sunset and twilight pictures have more contrast.

Dannmeyer also noted that the effects of using the Neodymium Oxide containing Neophane glass was studied during the summer and fall on the Elbe river and in the North and Baltic Seas. It was shown that clear sighting made red and green as already mentioned especially clear. External identification of a ship by the color of it's smoke stack, bottom paint, ensign and other elements was made much easier. If the weather was hazy or misty, so that one could see the other ship only as a silhouette gray against gray, color differences could still be seen that could not have been recognized with unaided sight. But what was immensely important was that ships that in hazy weather seemed to be the same distance apart, were seen to be at varied distance from one another, both location and movement were much easier to differentiate.

In addition, it is well known that on the Elbe at sunset, outgoing ships looking into the sunset have on occasion had optical difficulties caused by the blinding of the sun. Markers are difficult to distinguish, and even though ship pilots are exceedingly well informed, discerning an oncoming ship is sometimes exceedingly difficult. According to Dannmeyer, Neodymium Oxide containing Neophane glass prevents all of these things from happening to the eye. Along the lower Elbe one is able to distinguish a lengthening of the coastline even in hazy weather and thus seeing distances are actually extended by a nautical mile. On the North Sea it is possible to make out various vessels that would not have been discernible in the misty weather. The gray of the vessels appears darker than the surroundings through the eyeglasses. In the direction of the sinking sun, in which the eye could not distinguish objects, the vessels were clearly discernible through the Neodymium Oxide containing Neophane glass.

The present invention uses S-8801 didymium glass filters from Schott Glass Technologies. Didymium filters are known when used as photographic filters to enhance and intensify color and provide more color saturation and contrast in red, orange and brown without significantly affecting green colors. They are also known for their antiglare property. In the CRC handbook of Chemistry and Physics didymium is mentioned under Neodymium because when didymium was discovered it was thought to be an element and only later was it discovered to be a mixture of Neodymium and Praseodymium. It also states that didymium, of which Neodymium is a component is used for coloring glass for welders goggles. Because of this, the transmission characteristics of didymium and Neodymium glass are very similar as the only difference is that Neodymium glass lacks Praseodymium. Didymium glasses have been used for many years as eye protection for working with hot glass but are being slowly phased out as different glass compositions that offer better protection come on the market. Dannmeyer's description is also true for the filters used in this invention. While his observations are not from dyslexics, there are marked similarities between the visual problems described as being overcome and the visual problems that are characteristic of visual dyslexia.

Gouras (1981) gives a physiological explanation of how the eyes see colors which provides a partial explanation for the effectiveness of didymium filters in the invention of dyslexia glasses. He explains that there are three cone mechanisms in the human visual system, with peak sensitivities near 440 NM in the blue-violet, 540 NM in the green, and 610 NM in the orange. These mechanisms are loosely called blue green and red processes in vision because they may be roughly thought of as being affected, respectively, by blue, green and red light.

There are approximately 6 to 7 million green plus red cones per eye and less that 1 million blue cones. The green and red cones contribute towards seeing fine detail and contrasts, the blue cones do not. The blue cones are thought to provide mainly the means of distinguishing between yellow and white appearing objects, the blue cones mechanism is excited by blue light and inhibited by yellow light.

When mid-spectral (yellowish) images are in sharp focus on the retina, bluish wavelengths are out of focus. Low visual acuity is associated with the blue cone mechanism, and high visual acuity with the green plus red mechanism. The term “yellowish images” does not necessarily imply any yellow content in the light, since green plus red yields the sensation of yellow.

The cones feed their signals into various kinds of cells in and beyond the retina. Strongly cone opponent cells are those that are excited by one color and inhibited by another. The red-green contrast detectors contribute heavily to both luminance and color contrast, and also to the detection of differences between elements of a scene. They supply information on fine spatial detail.

The strongly cone opponent cells (associated with the green and red cones) are turned off or on by green light or red light, and are very unresponsive to yellow light. The red-green contrast detector is totally inhibited by yellow light.

Poor contrast sensitivity and visual acuity are often associated with visual dyslexia. As the dyslexia glasses remove at least 95% of the yellow light a large improvement would be expected.

Gregorio Weber is credited with predicting the intrinsic protein UV fluorescence due to aromatic amino acids and the first spectral resolution of these emissions. (Biophysical Journal 1998). In present day eye research this is now called autofluorescence to differentiate it from the fluorescence caused by fluorescent chemicals which are injected into the blood and used to image different parts of the eye especially the parts of the eye subject to deterioration associated with diabetes. Marmorstein (2002) investigated spectral profiling of the autofluorescence associated with lipofuscin excited at 364, 488, 568 and 633 nm light and found that the retinal pigment epithelium (RPE) had strong autofluorescence emissions at all wavelengths and Bruch's membrane exhibited strong autofluorescence when excited with 364 NM light. Fumihiko (1997) found autofluorescence could be measured directly in the cornea and lens. Light scatter through the lens increases as wavelengths get shorter than 480 NM. Filtering out light sources shorter than 480 NM thereby reducing intraocular light scatter and lens autofluorescence has been reported to improve visual performance by Zigman (1990). The human retina can respond to a light stimulus below 3990 nm; both the cone and rod pigments have secondary absorption maxima at 325 nm and 350 nm respectively Datrnell (1957). Thus UV in this region may result in some visual stimulation and possibly produce color confusion.

The dyslexia glasses would be expected to improve visual performance by removing about 40% of 420-480 NM light, virtually all UV light up to 360 NM and still being effective at 364 NM which causes strong autofluorescence of lipofuscin by reducing the amount of light scattered and much of the autofluorescence. Waltman (1978) needed to account for autofluorescence in his study of the retina blood barrier and Eldred (1982) had to remove the autofluorescence due to lipofusin to determine accurate fluorescence measurements. The autofluorescence of the rods and cones are both involved but only viewed as a factor that needs to be subtracted out. I speculate that the cause of the higher rate of poor depth perception in visual dyslexics is caused by different amounts of UV excited autofluorescence in either eye. The dyslexia glasses restore normal depth perception by removing all the UV autofluorescence making the eyes visually equal.

### BRIEF SUMMARY OF THE INVENTION

The invention is in the form of eyeglasses made with eyeglass frames with lenses made from didymium glass such as Schott S-8801 filter glass. Together the frames with lenses when worn by a visual dyslexic remove the visual problems associated with visual dyslexia. While the exact mechanism is unclear and must be inferred by the absorption spectra that are filtered, light scatter and autofluorescence are suspected as well as the glare and poor contrast and visual acuity caused by yellow light. Unlike prior art which claims a dyslexic's visual problems are caused by a person specific narrow band of color sensitivity that can best be removed by tinted lenses after a personal evaluation to determine that narrow band of color sensitivity, these dyslexia glasses require no personal evaluation.

Both the high success rate which makes a 100% satisfaction and 100% money back guarantee possible and low cost, presently $218, allows the dyslexia glasses to be a risk free and effective option for visual dyslexics of even moderate means. This is in sharp contrast to tinted glasses with their personal evaluations which are many times as expensive have lower success rates and no guarantees.

### BRIEF DESCRIPTION OF THE DRAWING

The 1/1 drawing is a graph of the transmission of light through 3.2 mm thick S-8801 didymium filter glass available from Schott Glass Technologies and used to make the lenses of the dyslexia glasses that remove the problems associated with visual dyslexia and expressed as % transmission V's wavelength. The drawing was copyrighted in 2004 by Aura Lens Products Inc. and I gratefully acknowledge their permission to use it. The drawing is presented in a landscape orientation to allow for better viewing.

### DETAILED DESCRIPTION OF THE INVENTION

The present invention removes the visual problems of visual dyslexia when worn by a visual dyslexic. It is in the form of eyeglasses that use S-8801 didymium glass filters from Schott Glass Technologies as the lenses. A standard thickness of 3.2 mm is used. The lenses should be ground and polished to be optically plano as well as tempered to meet federal regulations for eyeglass lenses. The choice of which style of eyeglass frame to use is arbitrary. There are no particular problems associated with the didymium glass and someone skilled in the art of manufacturing eyeglasses should be able to manufacture this invention. It is also possible to use standard techniques to manufacture prescription glasses from the didymium glass for those visual dyslexics also needing near and far sighted optical correction as well as other corrections such as stigmatism that are normally solved by inducing a predetermined shape into the lenses.

The evidence to date is anecdotal. When I started researching these glasses as a visual aid for dyslexia I soon found out that only about half the dyslexics had visual problems. By focusing on the idea of how to define the subgroup of dyslexics that are helped by these dyslexia glasses 100% of the time I arrived at this statement. For the dyslexics that can describe a visual problem that makes it hard to read these dyslexia glasses remove the visual problem 100% of the time. This has been true regardless of what the problem described has been. I particularly like this approach because if a dyslexic can describe a visual problem that makes it difficult to read then they can immediately determine if the problem is removed by the dyslexia glasses and determine that the problem comes back when the dyslexia glasses are removed. The removal of the visual problem results in an immediate increase in reading speed for the visual dyslexic that has already attained some reading skills and allows the more unskilled visual dyslexic to more easily attain those reading skills.

The increase in reading speed is easy to understand by looking at a few common visual problems of visual dyslexics that are corrected by the dyslexia glasses. For the visual dyslexic that has their words run together without spaces their visual problem makes reading a task equivalent to having to spell each word read to determine when to start the next word. This is the easiest condition to simulate, for example:

Forthevisualdyslexicthathastheirwordsruntogetherwithoutspacestheirvisualproble mmmesreadingataskequivalenttohavingtospelleachwordtodeterminewhentostartth enextwordread. It is easy to imagine how having the spaces restored by using the dyslexia glasses would increase reading speed.

For the visual dyslexic whose problem involves missing letters the example might look something like this to them:

Fo th visal dyslic tht as thei wors un togthr ithot space ther isua prblm aks rdng a tsk eqivalnt to havig o ell eah wod read to detrmine whe to art th nxt wor read. This type of visual problem makes reading almost like a guessing game and leads to accuracy mistakes. It is easy to imagine how having the missing letters restored by using the dyslexia glasses would increase reading speed and accuracy. This problem is also often described as having the letters obscured by light rather than just missing which is suggestive of autofluorescence and light scatter as the cause of the problem and the removal of the autofluorescence and light scatter as the mechanism by which the dyslexia glasses remove the problem.

The next two visual problems that the dyslexia glasses remove are not so easily depicted. There is a visual problem that is often described as having to look through a waterfall to read. I picture this as being a shirmmering veil of distortion that the visual dyslexic has to read through. Autofluorescence occurring in the eye lens and the resultant light scatter is very likely the cause of the problem and the removal of the autofluorescence and short wavelength light by the dyslexia glasses the mechanism that removes the problem.

Another problem described that the dyslexia glasses remove is where the words appear to jitter or move around making reading difficult. This is again most likely caused by a combination of light scatter and autofluorescence and also likely involves different locations of autofluorescence in both the lens and the pigments on the surface of the rods and cones and the removal of the autofluorescence and short wavelength light by the dyslexia glasses the mechanism for removal of the problem.

You might think with studies that characterize dyslexics as having problems with glare and poor contrast differentiation that this would be reported by some dyslexics as the problem that makes reading difficult. I have never had that reported as the problem. I do believe that glare and poor contrast differentiation are part of the problem but that for the visual dyslexic the problem manifests as a pattern that is more easily described. Coincidentally this is the one condition on which I can report on myself. I love to read and have spent most of my life near the beach. I tried for years to read on the beach on sunny days but even with sunglasses on I had poor contrast of the words where they appeared washed out and suffered from glare off the page to such an extent that I was distracted and had difficulty concentrating and always gave up after a page or two. I have tried the dyslexia glasses at the beach on sunny days and found that they improved the contrast and removed the glare so that I could read comfortably. I also experienced a fuzziness in the appearance of the words reading at the beach that I have never been able to decide whether it was caused by poor contrast differentiation or a reduction of acuity. The dyslexia glasses removed the fuzziness. I credit the glare removal and the increase in contrast to the removal of the yellow part of the spectrum by the dyslexia glasses.

It is visual problems such as these and others associated with the condition known as visual dyslexia that impairs a visual dyslexic's ability to read with normal speed and accuracy which together adversely effect reading comprehension and often results in poor academic achievement. The removal of the visual problems by the dyslexia glasses allow the visual dyslexic to see the written word in a normal manner without the visual distortions that characterize the visual problems. As the personal example of being able to read on a sunny beach with the dyslexia glasses shows, even a nondyslexic such as myself can read more easily with the dyslexia glasses at least in some circumstances.

I would also like to address the issue of dyslexics being of average or above average intelligence. I can make the idea right by adding one word. Diagnosed dyslexics are of average or above average intelligence. Half a bell curve for dyslexia V's intelligence never made sense. Granted that if a dyslexic is of below average intelligence then the lowered expectations for their reading skills makes it harder to determine a dyslexia impairment. I knew a 20 year old special ed. student that didn't know his alphabet that was diagnosed as being slightly mentally retarded. Puzzled about how to determine if the dyslexia glasses would help him I wrote the alphabet out once in order and once scrambled and asked him to match A-A and B-B etc. He could only match 13 letters. When he put on the dyslexia glasses he could match all 26 letters. In three days he could read letters from flash cards with the glasses and in a week he wrote his mother his first note with me spelling the words. He was the most visually impaired visual dyslexic I have seen to date.

Using the concept of a normal bell curve and the fact that the amount of autofluorescence is known to vary in the human eye I suggest that it would be possible to develop a measure of total visual distortion due to autofluorescence and light scatter and the presence of yellow light on which all dyslexics and non-dyslexics would all fall. As dyslexics comprise say 10% of the population it would be expected that they would be clustered towards the higher side of the bell curve. Just because someone is not dyslexic does not mean that they would see no benefit from using the dyslexia glasses. I suggest that where there are no symptoms of visual impairment such as being a visual dyslexic the perceived need for the benefit is low even though color enhancement, contrast and visual acuity would be improved.

The color enhancement and increase in contrast and visual acuity when wearing the dyslexia glasses is most noticeable outside on sunny days and the visual experience is very pleasurable. This has been noted by myself and many other people that are not dyslexic. While the use of the dyslexia glasses as sunglasses is trivial compared to the value of removing the problems associated with visual dyslexia I disclose that the use of the dyslexia glasses with their color enhancing, glare removing and acuity improving properties make wonderful sunglasses. Likewise the combination of these properties make the dyslexia glasses enjoyable for reading even for people who are not dyslexic.

Unfortunately not all visual dyslexics can describe their visual problem that makes it hard for them to read before trying the dyslexia glasses but do seem to be able to answer the question “Do you see all the words on the page in a uniform, sharp and focused manner?”. That is what the dyslexia glasses do. For the dyslexics that already see all the words in a uniform, sharp and focused manner without the dyslexia glasses no benefit is expected. I sell the dyslexia glasses off the web with a 100% satisfaction and 100% money back guarantee and suggest that the 5% return rate indicates anecdotal evidence that visual dyslexics can determine for themselves if they have visual dyslexia problems that will be helped by these dyslexia glasses by reading the web site.

For all the evidence that UV and visible light autofluorescence causes light scatter and can cause contrast and acuity loss and that glare can be removed while improving acuity and contrast by filtering out the yellow part of the spectrum, I have seen no indication that prior art has considered relating those facts to develop or find a filter to deal with those issues for dyslexics. I find no mechanism behind the idea that individual dyslexics can be helped by a individualistically determined particular color tint.

I would like to mention a mindset of the people involved in the prior art and most of dyslexia research. It is common in the field of psychology and education and in part necessary for most research in those fields. I do not believe it is appropriate for the treatment of visual dyslexia. The mindset is that if you can classify a percentage of people that will react a certain way to a given stimulus with good correlation you have arrived at the answer. There is no requirement that you can predict any individual response. This mindset has validity for such things as showing that phonics works better at teaching someone to read than sight reading or that certain parenting techniques for teaching discipline work better than others. The fact that some children don't learn reading with phonics or that a mass murderer was raised with the best parenting techniques doesn't invalidate phonics or the parenting technique. In psychology and education nothing is effective 100% of the time and so does not need to predict any individual behavior. This is how visual dyslexia has been treated in the prior art.

In Chemistry, physics and mathematics there is a different mindset that I believe is more appropriate for visual dyslexia. The mindset is the requirement to be able to predict individual results from given conditions. I would like to be able to say that if the total visual distortion from autofluorescence, light scatter and the presence of yellow light is measured then people having a measure greater than some value would have symptoms of visual dyslexia that make it hard to read and the dyslexia glasses would remove those symptoms. Unfortunately, even if such a scale is ever made and calibrated all it would show is a predisposition towards visual dyslexia because there are always other factors to consider. I believe that IQ and some sort of unknown sensitivity factor to visual information is also involved. I would think that a scale of visual distortion that would be normalized for IQ and a sensitivity factor might have some predictive value. It could be a valuable screening tool.

In a way I feel I have cheated in my invention of these dyslexia glasses. I haven't measured autofluorescence, IQ, and wouldn't even guess on how best to develop a sensitivity factor number to use. I can't even describe the whole group of visual dyslexics that will be helped by these glasses. In order for me to predict that a visual dyslexic will be helped by these dyslexia glasses I require that they be able to describe a visual problem that makes it hard to read. If they can do that then the anecdotal evidence is that 100% of the time the dyslexia glasses remove the visual problem. I met parents of a 10 year old who had been having trouble in school and they told me they were unhappy with the Sylvan Learning Center he had attended without much results. I had them ask the child if his problem was visual and he didn't know. I let them borrow a pair of dyslexia glasses to try and when I saw them a week later the father reported that the child read out loud about a third faster and more fluently with the glasses. When I asked the child if he could see differently with the glasses he reported that the lights over the words were gone and he could see the words clearly now. I am still trying to come up with a way how to determine who will be helped that doesn't require trying the glasses or being able to describe the visual problem that makes it hard to read as children seem to have difficulty expressing their visual problems or even if there is a visual problem. The return rate for the children's size glasses is about the same as the adult's at about 5%.

While not part of this patent application I suggest that the use of these dyslexia glasses to identify undiagnosed visual dyslexics can be carried out in an efficient and cost effective manner by a normally skilled teacher in about an hour for a 30 child classroom. As it would be expected that severe visually impaired visual dyslexics would concentrate in special education and remedial reading classes which are resource intensive, the identification of those students would allow them to be helped by the glasses and rejoin the less costly mainstream classes.

There is another very large group of visual dyslexics in this country that I feel could benefit from the use of these dyslexia glasses and that group is located in the prisons. With approximately 2 million people incarcerated in the country and 50-60% of them estimated to be dyslexics and roughly half of the dyslexics being visual dyslexics that means that there are 500,000 visual dyslexics in prison that could be helped by these dyslexia glasses. The high cost of recidivism would suggest that identifying the visual dyslexics and providing them with dyslexia glasses along with teaching them reading and employment skills would be a cost effective venture. This invention provides an opportunity to instigate such a program that would be impractical with the prior art.

I would like to relate a few stories of visual dyslexics that have been helped by these dyslexia glasses. I have chosen three people because their stories stood out as being different from what has been reported in the prior art. The first story is about a visual dyslexic that had been through the Irlen Clinic in Long Beach, Calif. and was not helped there. His visual problems were that he had such poor depth perception that the world looked flat and couldn't read white on green. That used to be important to him when all computer screens were presented with white letters on a green background and that was his motivation to seek help as he couldn't use the computer. With the advent of color screens by Apple computers that problem was solved. That still left freeway signs that he couldn't read but he had become used to only driving to places where he was familiar with landmarks. With the use of the dyslexia glasses he could read freeway signs but he was the most impressed with seeing the world in 3-D for the first time.

In the second story the person was a schizophrenic dyslexic who read slowly and often inaccurately. This was a problem as he liked to play the horses and often needed to read the racing form quickly and mistakes reading the number of the horse or race number had proved annoying and costly in the past. He was also the most psychologically aware person I had ever met as he was constantly checking his mental state to try and stay on the safe side of schizophrenic episodes. When he tried the dyslexia glasses his immediate reaction was that “I have to have a pair of these. I have never felt so relaxed.” He later reported that the dyslexia glasses also improved his reading speed and accuracy. I had heard visual dyslexia was a result of visual stress but never expected such a strong response. To him the removal of the problems associated with reading were secondary to the relaxation he felt mentally as a result of the dyslexia glasses.

The third story I consider to be my biggest success. A mother of 2 had a fourth grade dyslexic with a 6 year old younger brother. The mother purchased a pair of dyslexia glasses for the older brother off the web site and didn't give any feedback until her son lost the glasses a few months later. She ordered a second pair and wanted to know if they could be shipped FedEx overnight as her son couldn't do his school work without them. When the younger son's teacher reported that he was having trouble reading she let him try his older brother's glasses and the mother reported he read 7 pages of a book he had refused to look at before and so she ordered another pair. The mother recently reported that the older son was chosen to participate in a geography contest and he was very excited about it as he never expected to do well in school before getting the dyslexia glasses. Selling three pairs of glasses to the same family wasn't the success. Having the younger brother being helped a few months into first grade by the dyslexia glasses so his dyslexia would never adversely effect his performance in school was. It was also the first time that I have seen anecdotal evidence of the genetic link associated with dyslexia being helped by the use of the dyslexia glasses. It is also good example of being able to increase academic performance by use of the dyslexia glasses.

I have disclosed that the lenses used in the dyslexia glasses are made from S-8801 filter glass from Schott Glass Technologies 3.2 mm thick. The transmission spectra from these filters are on their web site as well as in Drawing 1/1 of this application. Other thickness than 3.2 mm of S-8801 glass would still be within the scope of this invention. Conceptually the glass could be made thinner and thinner until you could determine the thinnest glass that would help a particular dyslexic and charge for a personal evaluation as long as it met strength and safety requirements. I would consider this a step backward toward the prior art.

I disclose that other existing glasses such as Neodymium Oxide glass that have the same effective transmission spectra which reduces short wavelength, UV, and yellow light transmission are within the scope of this invention. As mentioned before the only difference between didymium and Neodymium glass is that Neodymium glass lacks Praseodymium. The filtering characteristic of absorbing the yellow part of the spectrum is attributed to the Neodymium component rather than the Praseodymium.

I disclose that new glass formulas that are designed to have similar transmission spectra for use as dyslexia glasses are within the scope of this invention.

I disclose that other materials designed to have similar transmission spectra for use as dyslexia glasses are within the scope of this invention.

I disclose that absorbing coatings put upon glass or other material designed to have similar transmission spectra for use as dyslexia glasses are within the scope of this invention.

I disclose that the use of this invention as sunglasses or reading glasses is within the scope of this invention.

I disclose that obvious and unessential modifications to this invention are within the spirit and scope of this invention.

1. Dyslexia glasses that remove visual problems when worn by a visual dyslexic such as;
words or letters that appear to move
words that appear to have missing letters
words that appear to be located behind a waterfall
letters that appear to be reversed or transposed
as well as other visual problems associated with visual dyslexia that impair a visual dyslexic's ability to read in a normal manner and results in one or more of the following:
low reading speed
problems with reading accurately
reading comprehension
and underachievement in academic endeavors comprised of eyeglass frames of arbitrary style which have lenses made from S-8801 didymium glass filters of a nominal thickness of 3.2 mm that have filtering properties of absorbing
over 95% of the yellow part of the light spectrum from 565-595 NM that is associated with the ability to
enhance color
enhance contrast
and reduce glare
UV protection up to 364 NM light associated with autofluorescence and light scatter
absorption of about 40% of 420-480 NM light associated with light scatter said filtering properties in combination have the ability to remove each and every visual problem associated with visual dyslexia for each and every visual dyslexic resulting in improved
reading speed,
reading accuracy
reading comprehension
and chances of academic success.

2. Dyslexia glasses as described in claim 1 used as reading glasses will enhance the reading experience of all dyslexics and all non-dyslexics both.

3. Dyslexia glasses as described in claim 1 are useful as sunglasses for all dyslexics and nondyslexics both.

4. Dyslexia glasses as described in claim 1 substituting reduced amounts of didymium are within the scope of this invention.

5. Dyslexia glasses as described in claim 1 substituting Neodymium Oxide for the didymium is within the scope of this invention.

6. Dyslexia glasses as described in claim 1 of unspecified composition but with essentially the same combination of light filtering properties are within the scope of this invention.

7. Dyslexia glasses as described in claim 1 may have lenses that are optically plano or with normal optical correction for near or far sighted visual dyslexics or other corrections such as bifocals as needed for the particular user and prescribed by a doctor.
